(19) United States
(12) Patent Application Publication
(10) Pub. No.: US 2023/0421970 A1
(43) Pub. Date: Dec. 28, 2023

(54) SYSTEM AND METHOD FOR PERSONALIZED, IMAGE ANALYSIS BASED POSITIONING OF HEARING AIDS

(71) Applicant: TUNED LTD., Gan Yoshiya (IL)

(72) Inventors: Omri GAVISH, Gan Yoshiya (IL); Ron GANOT, Kfar Saba (IL)

(21) Appl. No.: 18/242,149

(22) Filed: Sep. 5, 2023

Related U.S. Application Data
(63) Continuation-in-part of application No. 17/739,129, filed on May 8, 2022.

(51) Int. Cl. H04R 25/00; G06V 40/16; G06V 10/10

(52) U.S. Cl. CPC H04R 25/30; G06V 40/166; G06V 40/172; G06V 10/17

(57) ABSTRACT

System and method for personalized positioning of hearing aids, in particular, for in a home-setting, based on imaging and image processing.

### RELATED APPLICATIONS

This application is a continuation in part of U.S. Ser. No. 17/739,129, entitled “SYSTEM AND METHOD FOR PERSONALIZED, IMAGE ANALYSIS BASED POSITIONING OF HEARING AIDS” and filed on May 8, 2022.

### TECHNOLOGICAL FIELD

The present disclosure generally relates to a system and method for personalized positioning of hearing aids, in particular, for use in a home-setting, and specifically to personalized positioning of hearing aids, based on imaging and image processing.

### BACKGROUND

Proper hearing aid fitting is crucial for a successful hearing rehabilitation process. For BTE/RIC/RITE/Slim tube hearing aids, the appropriate position of the hearing, including the angle of the hearing aid, is essential to the efficiency of the directional microphone, which in turn is essential to in-noise hearing. Furthermore, proper insertion of the hearing aid tube/receiver in the ear canal is essential to efficient delivery of sounds into the ear canal as well as to avoiding possible acoustic feedback or avoiding wearing discomfort. In addition, proper insertion also reduces the visibility of the hearing aid, thereby minimizing the emotional reaction of the hearing aid user and reactions from social surroundings. Not least, proper insertion is necessary to avoid loss of the hearing aids during use.

Many first-time users experience difficulty in correctly inserting hearing aids, which may lead to loss of the hearing aid, lower sound quality, wearing discomfort, lack of proper amplification and especially impaired hearing in noisy environments, ultimately leading to low compliance and satisfaction.

There thus remains a need for a system and method for determining hearing aid positioning correctness and/or for guided insertion of the hearing aids.

### SUMMARY

There is provided herein a system and method for personalized fitting of hearing aids, which enables a hearing aid user to ensure correct insertion of his/her hearing aid, especially in a home-setting, without the assistance of a hearing care professional.

Advantageously, the herein disclosed system and method are based on imaging and image processing and thus enable providing a personalized guidance to the user, while taking into consideration the unique anatomy of the user's ear. This may be performed by calculating the position of different parts of the hearing aid relative to their optimal position relative to at least one anatomical landmark of the user's ear.

According to some embodiments, the method also provides guided positioning of the hearing aid to the subject's ear, once again while taking into consideration the unique anatomy of the user's ear, so as to reduce misplacement up-front.

Additionally, according to some embodiments, the method may identify whether a change needs to be made to the position of the hearing aid and/or a part thereof in order to achieve a correct fit of a hearing aid to the unique anatomy of the user's ear. According to some embodiments, the method may include providing guidance on repositioning the hearing aid and/or a part thereof.

According to some embodiments, the method may identify whether a structural element of the hearing aid needs to be changed in order to achieve a correct fit of a hearing aid to the unique anatomy of the user's ear. According to some embodiments, the method may identify which structural element of the hearing aid needs to be changed in order to achieve a correct fit of a hearing aid to the unique anatomy of the user's ear. According to some embodiments, the method may include providing guidance on changing a structural element of the hearing aid.

Advantageously, the herein disclosed system and method enable validated positioning of the hearing aid remotely from the user's hearing aid professional.

Some embodiments relate to a computer implemented method for determining hearing aid position correctness with respect to the unique anatomy of a specific user's ear, the method comprising:
requesting, via a user interface, a hearing aid user to capture and/or upload a plurality of images, the plurality of images comprising at least one frontal face image and at least one side face image, wherein the plurality of images is captured while the user is wearing a hearing aid,
applying a facial landmark algorithm on the plurality of images to identify a position of an ear of the user, at least one anatomical landmark of the ear and one or more parts of the hearing aid;
deriving, from the determined position of the at least one anatomical landmark of the ear of the user and from the one or more parts of the hearing aid, one or more features related to a relative position of the hearing aid relative to the at least one anatomical landmark of the ear of the user in the plurality of images;
determining the correctness of a position of the hearing aid by applying a machine learning algorithm on the one or more features, wherein the machine learning algorithm is trained using a training set comprising a large plurality of images of ears with hearing aids and a plurality of labels associated with the large plurality of images, each label indicating whether the hearing aid is correctly or incorrectly positioned, wherein the large plurality of images comprises images of ears of different subjects and wherein the large plurality of images comprises at least two images of each ear from different angles thereof;
wherein the machine algorithm is trained to differentiate between the following scenarios:
a) the hearing aid is correctly positioned;
b) the hearing aid is incorrectly positioned; and
c) a structural element of the hearing aid needs to be changed;
providing an indication to the user regarding the correctness of the hearing aid position, wherein if the hearing aid is correctly positioned, the indication is indicative of same;
wherein if incorrect positioning is identified, the indication comprises a request to reposition the hearing aid, or
wherein if changing of a structural element of the hearing aid is required, the indication comprises a request to change the structural element.

According to some embodiments, the method may include extracting at least one anatomical landmark of the user's ear, wherein the extracting may include applying an image analysis algorithm on the plurality of images. According to some embodiments, at least one landmark may include a climax of the helix, an angle of the pinna relative to the head, the crus of helix, the tragus, the intertragic notch, the antitragus, an entrance of the external auditory canal, the cavum and a d-shape of the pinna, or any combination thereof. Each possibility is a separate embodiment.

According to some embodiments, the one or more features may include two or more of: a distance between a climax of a helix of the ear of the user and a connection point between a body and a tube of the hearing aid, a horizontal and/or vertical distance between an upper band of the tube of the hearing aid and a crus of the helix of the ear of the user, a horizontal and/or vertical distance between a middle band of the tube of the hearing aid and the cymba of the ear of the user, a horizontal position of the hearing aid tube and/or a dome of the hearing aid relative to the concha and/or the entrance of the external auditory meatus of the ear of the user, a position of a lower part of the hearing aid tube in a vertical and/or horizontal plane relative to a tragus, antitragus and/or intertragic notch of the ear of the user. Each possibility is a separate embodiment.

According to some embodiments, the at least one side face image may include at least one left-side face image and at least one right-side face image. Optionally, the plurality of images may be still images. Optionally, the plurality of images may be derived from a video.

According to some embodiments, the request to reposition the hearing aid may include instruction regarding how to reposition, such as to change an angle of a body of the hearing aid, instruction to position the hearing aid lower or higher than a current position, instruction regarding positioning of a wire/tube on the pinna, instructions regarding position and depth of a receiver/tube inside the ear and/or ear canal, instructions to change a dome of the hearing aid, instructions to change a length of a hearing aid tube and/or a receiver wire or any combination thereof. Each possibility is a separate embodiment.

According to some embodiments, the structural element may be selected from a tube length, a tube depth, a standard silicon dome size, a standard silicon dome type, or a custom made earmold. Each possibility is a separate embodiment.

According to some embodiments, the method may be executed via an App and wherein the capturing of the plurality of images is carried out using a camera of a mobile phone or tablet installed with the App.

According to some embodiments, the method may include guiding the capturing of the plurality of images, such as the instructing the user to position the camera for capturing a frontal face image and determining correct face position relative to an image frame of the camera by applying a face recognition tool, and/or instructing the user to turn the face sideways and determining correct face position based on automatic identification of the ear of the user.

According to some embodiments, the method may include an initial step of guided insertion/positioning of a hearing aid.

According to some embodiments, the large plurality of images may include a first image of an ear with a correctly positioned hearing aid and a second image of the same ear with an incorrectly positioned hearing aid. According to some embodiments, the large plurality of images may include a first image of an ear with a correctly positioned hearing aid and a second image of a different ear with an incorrectly positioned hearing aid.

According to some embodiments, the method may include extracting a plurality of features from each of the large plurality of images. According to some embodiments, the method may include selecting a subset of features from the plurality of features, which subset have a predictive value above a predetermined threshold.

Some embodiments may relate to a system for determining hearing aid positioning correctness with respect to the unique anatomy of a specific user's ear, the system comprising a processing logic configured to:
request a hearing aid user to capture a plurality of images, the plurality of images comprising at least one frontal face image and at least one side face image, wherein the plurality of images is captured while the user is wearing a hearing aid;
process the plurality of images to determine the position of at least one anatomical landmark of the user's ear and of one or more parts of the hearing aid, wherein the processing comprises applying a facial landmark algorithm on the plurality of images to identify a position of an ear of the user, at least one anatomical landmark of the ear and one or more parts of the hearing aid;
deriving, from the determined position of the at least one anatomical landmark of the ear of the user and from one or more parts of the hearing aid, one or more features related to a relative position of the hearing aid relative to the at least one anatomical landmark of the ear of the user in the plurality of images;
determine the correctness of a position of the hearing aid by applying a machine learning algorithm on the one or more derived features, wherein the machine learning algorithm is trained using a training set comprising a large plurality of images of ears with hearing aids and a plurality of labels associated with the large plurality of images, each label indicating whether the hearing aid is correctly or incorrectly positioned, wherein the large plurality of images comprises images of ears of different subjects and wherein the large plurality of images comprises at least two images of each ear from different angles thereof;
wherein the machine algorithm is trained to differentiate between the following scenarios:
a) the hearing aid is correctly positioned;
b) the hearing aid is incorrectly positioned; and
c) a structural element of the hearing aid needs to be changed;
provide an indication to the user regarding the correctness of the hearing aid position, wherein if the hearing aid is correctly positioned, the indication is indicative of same;
wherein if incorrect positioning is identified, the indication comprises a request to reposition the hearing aid, or
wherein if changing of a structural element of the hearing aid is required, the indication comprises a request to change the structural element.

Some embodiments relate to a computer implemented method for determining hearing aid position correctness with respect to the unique anatomy of a specific user's ear, the method comprising:
requesting, via a user interface, a hearing aid user to capture and/or upload a plurality of images, the plurality of images comprising at least one frontal face image and at least one side face image, wherein the plurality of images is captured while the user is wearing a hearing aid,
applying a facial landmark algorithm on the plurality of images to identify a position of an ear of the user, at least one anatomical landmark of the ear and one or more parts of the hearing aid;
deriving, from the determined position of the at least one anatomical landmark of the ear of the user and from the one or more parts of the hearing aid, one or more features related to a relative position of the hearing aid relative to the at least one anatomical landmark of the ear of the user in the plurality of images;
determining the correctness of a position of the hearing aid by applying a machine learning algorithm on the one or more features, wherein the machine learning algorithm is trained using a training set comprising a large plurality of images of ears with hearing aids and a plurality of labels associated with the large plurality of images, each label indicating whether the hearing aid is correctly or incorrectly positioned, wherein the large plurality of images comprises images of ears of different subjects and wherein the large plurality of images comprises at least two images of each ear from different angles thereof;
wherein the machine algorithm is trained to identify whether a structural element of the hearing aid needs to be changed;
wherein if changing of a structural element of the hearing aid is required, the algorithm is configured to identify which structural element needs to be changed, and to provide a request to the user to change the identified structural element.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In block diagrams and flowcharts, certain steps may be conducted in the indicated order only, while others may be conducted before a previous step, after a subsequent step or simultaneously with another step. Such changes to the orders of the step will be evident for the skilled artisan.

FIG. 1 is an illustration of the herein disclosed method for verifying correct hearing aid positioning, according to some embodiments.

FIG. 2 is a flow chart of the herein disclosed computer implemented method for verifying correct hearing aid positioning, according to some embodiments.

FIG. 3 is a flow chart of the herein disclosed computer implemented method for verifying fit of hearing aid parts, according to some embodiments.

FIG. 4 is an illustrative image of a hearing aid and its parts, according to some embodiments.

FIG. 5 is an illustrative image for guided distinguishing between a left and right hearing aid, according to some embodiments.

FIG. 6-FIG. 25, are illustrative images visualizing the steps for insertion of a right hearing aid, according to some embodiments.

FIG. 26-FIG. 40, are illustrative images visualizing the steps for insertion of a left hearing aid, according to some embodiments.

FIG. 41-FIG. 48, are illustrative images visualizing the steps for verifying the position of the hearing aid parts, issuing an indication to the user if changing of a part of the hearing aid is needed, and providing guidance for changing the part, in accordance with some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

According to some embodiments, there is provided a computer implemented method for determining hearing aid positioning correctness (and system for implementation of same). According to some embodiments, the method may include: requesting, via a user interface (e.g. a dedicated mobile App), a hearing aid user to capture and/or upload a plurality of images, the images captured while the user is wearing his/her hearing aid, processing the plurality of images to determine the position of one or more parts of the hearing aid relative to at least one anatomical landmark of the user's ear, wherein the processing comprises applying an image analysis algorithm on the plurality of images; determining the correctness of the position of the hearing aid and/or a part thereof by applying a trained machine learning algorithm on the determined position of the hearing aid and/or a part thereof relative to the at least one anatomical landmark of the user's ear in the plurality of images; providing an indication to the user (e.g. via the App interface) regarding the correctness of the hearing aid position; and if the position of the hearing aid and/or a part thereof is determined to be incorrect, providing instructions/guidance to the user on how to repositioning the hearing aid and/or a part thereof, and optionally iterating and/or repeating this process until correct fit of the hearing aid to the unique anatomy of the user's ear is achieved.

According to some embodiments, there is provided a computer implemented method for determining hearing aid positioning correctness (and system for implementation of same). According to some embodiments, the method may include: requesting, via a user interface (e.g. a dedicated mobile App), a hearing aid user to capture and/or upload a plurality of images, the images captured while the user is wearing his/her hearing aid, processing the plurality of images to determine the position of one or more parts of the hearing aid relative to at least one anatomical landmark of the user's ear, wherein the processing comprises applying an image analysis algorithm on the plurality of images; determining the correctness of the position of the hearing aid and/or a part thereof by applying a trained machine learning algorithm on the determined position of the hearing aid and/or a part thereof relative to the at least one anatomical landmark of the user's ear in the plurality of images; determining whether a change of one or more structural elements is needed to achieve the correct fit of the hearing aid; and if a change is determined to be needed to achieve the correct fit of the hearing aid identifying which structural elements need to be changed, and providing instructions/guidance to the user on how to change one or more parts of the hearing aid, and optionally iterating and/or repeating this process until correct fit of the hearing aid to the unique anatomy of the user's ear is achieved.

Advantageously, the method may not require a user to obtain a reference image of his/her own ear with a correctly positioned hearing aid. Advantageously, the method may not require side-by-side comparison of a reference image of a user, and/or a generic image, including a correctly positioned hearing aid in the user's ear, and one or more of the plurality of captured and/or uploaded images of the user's ear.

Advantageously, the method may provide a personalized guided image analysis that takes into consideration the unique anatomy of each specific user's ear. According to some embodiments, a machine learning algorithm may be applied directly on one or more features related to a relative position of the hearing aid relative to at least one anatomical landmark of the user's ear, as derived from the plurality of captured and/or uploaded images, to determine directly from the plurality of images of the user's ear whether the hearing aid is correctly positioned or not with respect to the unique anatomy of the user's ear. According to some embodiments, a machine learning algorithm may be applied directly on one or more features related to a relative position of the hearing aid relative to at least one anatomical landmark of the user's ear, as derived from the plurality of captured and/or uploaded images, to determine directly from the plurality of images of the user's ear whether a structural element of the hearing aid is needed in order to achieve a correct fit of the hearing aid to the unique anatomy of the user's ear.

Advantageously, the machine learning algorithm may be trained to identify a need to change the position of a hearing aid and/or part thereof to correctly position the hearing aid in the user's ear according to his/her unique anatomy. Moreover, advantageously, the machine learning algorithm may be trained to suggest a solution to the identified need, e.g., requesting that the hearing aid and/or part thereof be repositioned. Optionally, guidance may be provided to the user on repositioning the hearing aid and/or part thereof.

Additionally, the machine learning algorithm may be trained to identify a need to change a structural element (part) of the hearing aid to correctly position the hearing aid in the user's ear according to his/her unique anatomy. Moreover, advantageously, the machine learning algorithm may be trained to suggest a solution to the identified need, e.g., identifying which part needs to be changed in order to fit the unique anatomy of a user's ear, and requesting that the specific part be changed. Optionally, guidance may be provided to the user on changing the hearing aid part.

According to some embodiments, if the position of the hearing aid is determined to be correct, an indication may be provided to the user signaling that the hearing aid is correctly positioned. Non-limiting examples of a suitable signal/indication is a text message, a message provided through the hearing aid, a sound provided through the hearing aid, an indicator (e.g., a green light) provided through the App or any other suitable signal or combination of signals. Each possibility is a separate embodiment.

Alternatively, according to some embodiments, if the position of the hearing aid and/or part thereof is determined to be incorrect, an indication may be provided to the user signaling that the hearing aid is incorrectly positioned. Non-limiting examples of a suitable signal/indication is a text message, a message provided through the hearing aid, a sound provided through the hearing aid, an indicator (e.g., a red light) provided through the App or any other suitable signal or combination of signals. Each possibility is a separate embodiment.

Alternatively, according to some embodiments, if a structural element of the hearing aid is determined to need to be changed, the machine learning algorithm may be trained to identify which structural element needs to be changed in order to fit the unique anatomy of the user's ear, and an indication may be provided to the user signaling which structural element needs to be changed. Non-limiting examples of a suitable signal/indication is a text message, a message provided through the hearing aid, a sound provided through the hearing aid, an indicator (e.g., a red light) provided through the App or any other suitable signal or combination of signals. Each possibility is a separate embodiment.

According to some embodiments, in addition to or instead of the signal, a request may be provided to the user (via the App and/or via the hearing aid) to reposition the hearing aid and/or part thereof, in order to obtain the correct fit of the hearing aid to the unique anatomy of the user's ear. Optionally, guidance may be provided to the user (e.g., via the App and/or via the hearing aid) on how to reposition the hearing aid and/or a part thereof. Optionally, such an adjustment may be followed by recapturing of the plurality of images, and analysis thereof, to determine if the fit of the hearing aid is correct. Optionally, this process may be iterated and/or repeated until a correct fit of the hearing aid to the unique anatomy of the user's ear is achieved.

Alternatively, and/or additionally, according to some embodiments, in addition to or instead of the signal, a request may be provided to the user (via the App and/or via the hearing aid) to change a specific structural element of the hearing aid in order to obtain the correct fit of the hearing aid to the unique anatomy of the user's ear. Optionally, guidance may be provided to the user (e.g., via the App and/or via the hearing aid) on how to change the structural element. Optionally, such an adjustment may be followed by recapturing of the plurality of images, and analysis thereof, to determine if the fit of the hearing aid is correct. Optionally, this process may be iterated and/or repeated until a correct fit of the hearing aid is achieved.

According to some embodiments, the request to reposition the hearing aid may include providing vocal and/or visual instruction regarding how to reposition the hearing aid and/or parts thereof. According to some embodiments, the instructions may include instructions to change an angle of the body of the hearing aid, instruction to position the hearing aid body lower or higher than the current position, instruction regarding positioning of the wire/tube on the pinna, instructions regarding position and depth of the receiver/tube inside the ear and/or ear canal, or any combination thereof. Each possibility is a separate embodiment.

Additionally, and/or alternatively, according to some embodiments, the request to change a structural element may include providing vocal and/or visual instruction regarding how to change a part of the hearing aid to achieve the correct fit with the unique anatomy of the user's ear. According to some embodiments, the instructions may include instructions to change the dome of the hearing aid, instructions to change a diameter of the hearing aid tube, instructions to change a length of the hearing aid tube and/or the receiver wire or any combination thereof. Each possibility is a separate embodiment.

According to some embodiments, the change in the structural element (part) of the hearing aid may be a change in the length of the hearing aid tube, the diameter of the hearing aid tube, the depth of the hearing aid tube, a change in the hearing aid dome utilized, such as, but not limited to, changing the size of the hearing aid dome (e.g. from a plurality of standard sizes), changing the type of the hearing aid dome (e.g. from a plurality of standard dome types), or changing to a custom made earmold. Each possibility is a separate embodiment.

As used herein, according to some embodiments, the term “hearing aid,” may refer to any type of hearing enhancement device, including medical devices prescribed for the hearing impaired, and personal sound amplification products (PSAP) generally not requiring a prescription or a medical waiver. The device type or “style” may be any invisible in the canal (IIC), in-the-canal (ITC), in the ear (ITE), a receiver in the canal (RIC), or behind the ear (BTE). A canal hearing aid may refer herein to any device partially or fully inserted in the ear canal.

As used herein, according to some embodiments, the terms “mobile application” and “App” may be used interchangeably, and may refer to a computer program or software application designed to run on a mobile device such as a mobile phone, tablet, laptop, smart watch, smart glasses, and/or virtual reality device.

As used herein, according to some embodiments, the terms “part” and “structural element” may be used interchangeably, and may refer to a component of the hearing aid. Non-limiting examples of structural elements include the body of the hearing aid, the hearing aid tube, the connection element connecting between the hearing aid body and the hearing aid tube, the upper band of the tube, the lower band of the tube, the retainer of the tube, the silicone dome or any other hearing aid component.

As used herein, according to some embodiments, the term “plurality” with regards to the number of images captured and/or uploaded may include 2, 3, 4, 5, 6, 7, 8, 9, 10, or more images. As used herein, according to some embodiments, the term “large plurality” with regards to the number of images utilized during the training of the one or more machine learning algorithms applied may refer to at least 100 images, at least 200 images, at least 500 images, at least 1,000 images, or at least 2,000 images.

As used herein, according to some embodiments, the term “processing” with regards to analyzing the plurality of images to determine the position of one or more parts of the hearing aid and at least one anatomical landmarks of the user's ear, may refer to or include applying an image analysis algorithm on the plurality of images.

According to some embodiments, the image analysis may comprise several steps:
Step 1: Localize the face in the image.
Step 2: Detect the ear(s) in the localized face.
Step 3: Detect anatomical landmarks of the ear.
Step 4: Detect the positions of the hearing aid and the hearing aid's parts on the ear relative to the anatomical landmarks of the ear.
Step 5: Determine if the position of the hearing aid and/or parts thereof on the ear are correctly positioned.

Step 6: If an incorrect position of the hearing aid and/or part thereof has been determined with respect to the unique anatomy of a specific user's ear, ascertain how an incorrect position of the hearing aid and/or part thereof may be repositioned to achieve correct fit of the hearing aid according to the user's unique anatomy.

According to some embodiments, the image analysis may comprise several steps:
Step 1: Localize the face in the image.
Step 2: Detect the ear(s) in the localized face.
Step 3: Detect anatomical landmarks of the ear.
Step 4: Detect the positions of the hearing aid and the hearing aid's parts on the ear relative to the anatomical landmarks of the ear.
Step 5: Determine if the position of the hearing aid and/or parts thereof on the ear are correctly positioned.
Step 6: If a structural deficiency of the hearing aid and/or part thereof has been determined with respect to the unique anatomy of a specific user's ear, ascertain which part of the hearing aid may be changed to achieve correct fit of the hearing aid according to the user's unique anatomy.

According to some embodiments, localizing the face in the image may comprise applying face detection algorithms, such as, but not limited to, a pre-trained HOG+Linear SVM object detector specifically for the task of face detection. According to some embodiments, localizing the face in the image may comprise applying deep learning-based algorithms for face localization. According to some embodiments, localizing the face in the image may comprise determining the (x, y)-coordinates of the face in the image.

According to some embodiments, detecting the ear(s) in the image may comprise applying a facial landmark algorithm/detector. According to some embodiments, detecting the ear(s) in the image may comprise using a training set of labeled ears in a large plurality of images. These images may be manually labeled, specifying specific (x, y)-coordinates of regions surrounding the ear. Given this training set, a machine learning algorithm such as, but not limited to, an ensemble of regression trees may be trained to detect a subject's ear(s). Once the training is completed, the algorithm may be applied to detect the ear in unknown images with high quality predictions.

As used herein, according to some embodiments, the term “unknown image” may relate to an image which was not included in the training set and/or was not labeled.

It is understood that similar methods may be applied to identify anatomies/landmarks of the ear. According to some embodiments, once the ear is detected and x,y coordinates provided, the machine learning algorithm may be trained to identify any of various anatomical landmarks of the ear. Once the training of the machine learning algorithm is completed, the algorithm may be applied to detect not only the ear, but also the anatomical landmarks of the ear in unknown images.

As used herein, according to some embodiments, the terms “anatomical landmark”, “anatomical fiducial”, “anatomy of the ear” and “biometric feature” may be used interchangeably, and may refer to substructures of the human ear such as, but not limited to, the climax of the helix, the angle of the pinna relative to the head, the crus of helix, the tragus, the intertragic notch, the antitragus, the entrance of the external auditory canal, the cavum, the d-shape of the pinna, or any combination thereof. Each possibility is a separate embodiment.

According to some embodiments, same or similar machine learning algorithms may be applied for detection of the hearing aid worn by the user as well as parts thereof. According to some embodiments, the training set may include a large plurality of images with labeling of the hearing aid and/or its parts, such as, but not limited to, the body of the hearing aid, the hearing aid tube, the connection element connecting between the hearing aid body and the hearing aid tube, the upper band of the tube, the lower band of the tube, the retainer of the tube, the silicone dome or any combination thereof. Each possibility is a separate embodiment.

According to some embodiments, since the ears are positioned on the side of the subject's head, the large plurality of images on which the training of the machine learning algorithm is performed and/or the images captured and/or uploaded may include at least one frontal face image and at least one side face image. According to some embodiments, when the user is wearing hearing aids on both ears, the plurality of images may include at least one frontal face image, at least one right-side image and at least one left-side image.

According to some embodiments, the large plurality of images on which the training of the machine learning algorithm is performed and/or the images captured/uploaded may be still images and/or image frames derived from a video.

According to some embodiments, the images captured and/or uploaded may be captured using the camera of a mobile phone, smartwatch, smart glasses, virtual reality device, or tablet installed with the App and/or connected to the cloud.

According to some embodiments, the method may further include guiding the capturing of the plurality of images. According to some embodiments, the guiding may comprise instructing the user to position the camera for capturing a frontal face image and determining correct face position relative to the camera's image frame by applying a face recognition tool. Optionally, the face recognition tool may be custom made to the App and/or may be part of the normal face detection of mobile cameras.

According to some embodiments, a custom-made face detection tool for the capturing of the images may be configured to ensure that the ear, and optionally particular landmarks thereof, is seen in the image. According to some embodiments, the face detection tool utilized for the capturing of the images may be part of the herein described image analysis algorithms. According to some embodiments, the face detection tool may instruct the user to turn their face sideways, adjusting the position of the camera, adjusting the position of the user's head, to move the user's hair, to ensure that the ear, and optionally, particular landmarks thereof is/are seen in the image. According to some embodiments, the face detection tool may determine correct face position, e.g., based on automatic identification of the subject's ear.

According to some embodiments, the images may include at least two images of a same ear from different angles thereof (e.g., from the side, from the front, and optionally also at an angle, or from the back).

According to some embodiments, the images may include images of ears of different subjects.

According to some embodiments, the images may include images of ears of different subjects wearing hearing aids.

According to some embodiments, the machine algorithm may be trained to differentiate between the following scenarios in the images: a) the hearing aid is correctly positioned; b) the hearing aid is positioned incorrectly; and c) a structural element of the hearing aid needs to be changed. According to some embodiments, the algorithms may be part of the herein described image analysis algorithms.

According to some embodiments, the images include images of same subjects (same or different) wearing different hearing aids.

According to some embodiments, a training set for determining the correctness of the position of a hearing aid and/or part thereof may include a first subset of images of ear(s) with a correctly positioned hearing aid and/or part thereof, and a second subset of images of the same ear(s) with an incorrectly positioned hearing aid and/or part thereof. According to some embodiments, a training set for determining the correctness of the position of a hearing aid and/or part thereof may include a first subset of images of ear(s) with a correctly positioned hearing aid and/or part thereof, and a second subset of images of the different ear(s) with an incorrectly positioned hearing aid and/or part thereof.

According to some embodiments, a training set for determining if change of a structural element of the hearing aid is needed may include a first subset of labeled images of ear(s) with a structurally suitable hearing aid and/or part thereof, and a second subset of labeled images of the same ear(s) with a structurally deficient hearing aid and/or part thereof. According to some embodiments, a training set for determining if change of a structural element of the hearing aid is needed may include a first subset of labeled images of ear(s) with a structurally suitable hearing aid and/or part thereof, and a second subset of labeled images of different ear(s) with a structurally deficient hearing aid and/or part thereof.

According to some embodiments, a training set for determining which structural element of the hearing aid needs to be changed may include a first subset of sub-labeled images of ear(s) with a structurally suitable hearing aid and/or part thereof, and a second subset of sub-labeled images of the same ear(s) with a structurally deficient hearing aid and/or part thereof. According to some embodiments, determining which structural element of the hearing aid needs to be changed may include a first subset of sub-labeled images of ear(s) with a structurally suitable hearing aid and/or part thereof, and a second subset of sub-labeled images of different ear(s) with a structurally deficient hearing aid and/or part thereof. Optionally, the sub-labels may identify each structural element and/or the structural deficiency thereof with respect to a specific anatomical landmark of an ear, e.g., tube too long for specific user's ear, tube too short for specific user's ear, dome too big for specific user's ear, dome too small for specific user's ear, tube diameter to wide for specific user's ear, tube diameter too narrow for specific user's ear, upper band or lower band of tube too loose or too tight for specific user's ear, etc.

As used herein, according to some embodiments, the term “structural deficiency” may relate to the bad and/or incorrect fit of a structural element with respect to a specific anatomical landmark of a user's ear, e.g., tube too long for specific user's ear, tube too short for specific user's ear, dome too big for specific user's ear, dome too small for specific user's ear, tube diameter to wide for specific user's ear, tube diameter too narrow for specific user's ear, upper band or lower band of tube too loose or too tight for specific user's ear etc. Optionally, the term “structural deficiency” may relate to a defective structural element, e.g., a structural element that has been stretched, deformed, discolored, and/or been visibly damaged.

According to some embodiments, the images may be manually labeled, specifying specific (x, y)-coordinates of regions surrounding the ear. Given this training set, a machine learning algorithm such as, but not limited to, an ensemble of regression trees may be trained to detect a hearing aid and/or part thereof and/or at least one anatomical landmark. According to some embodiments, once the training is completed, the algorithm may be applied to identify an incorrect position of the hearing aid and/or part thereof in unknown images with high quality predictions. Additionally, and/or alternatively, according to some embodiments, once the training is completed, the algorithm may be applied to identify a structural deficiency of the hearing aid and/or a part thereof in unknown images with high quality predictions.

According to some embodiments, the determining of the correctness of the subject's ear may comprise applying a machine learning algorithm (same or different than that used for the ear detection and/or hearing aid detection), also referred to herein as the “correctness-of-positioning detector” or “classifier”. According to some embodiments, the machine learning algorithm applied may be trained on a training set comprising: a large plurality of images of ears with hearing aids and/or coordinates indicative thereof, and a plurality of labels associated with the large plurality of images (and/or the coordinates), each label indicating whether the hearing aid is correctly or incorrectly positioned.

Non-limiting examples of suitable classifier algorithms include: logistic regression algorithms, Naive Bayes algorithms, K-Nearest Neighbors algorithms, Decision Tree algorithms, Support Vector Machines algorithms or any combination thereof. Each possibility is a separate embodiment.

According to some embodiments, applying the “correctness-of-positioning detector/classifier” may comprise extracting a plurality of features from each of the large plurality of images. According to some embodiments, applying the “correctness-of-positioning detector” may further comprise selecting a subset of features from the plurality of extracted features, which subset may have a predictive value above a predetermined threshold.

According to some embodiments, the determining the correctness of a position of the hearing aid may include applying a machine learning algorithm on the one or more features, wherein the machine learning algorithm may be trained using a training set comprising a large plurality of images of ears with hearing aids and a plurality of labels associated with the large plurality of images. According to some embodiments, each label may indicate whether the hearing aid is correctly or incorrectly positioned. According to some embodiments, the large plurality of training images may comprise images of ears of different subjects. According to some embodiments, the large plurality of training images may comprise at least two images of each ear from different angles thereof.

According to some embodiments, the correctness of the position of the hearing aid and/or parts thereof may identify an incorrect position of the hearing aid and/or part thereof by applying a machine learning algorithm on the determined position of the hearing aid and/or part thereof and at least one anatomical landmark of the user's ear.

According to some embodiments, the determining of the correctness of the position of the hearing aid and/or a part thereof by applying a machine learning algorithm on the determined position of the hearing aid and/or a part thereof and at least one anatomical landmark of the user's ear may comprise extracting features from the images such as, but not limited to, features regarding a relative distance and/or relative placement of the determined location of the hearing aid and/or parts thereof relative to the anatomical landmark of the ear. Non-limiting examples of suitable features for extraction include: a distance between the climax of the helix and a connection point between a body and tube of the hearing aid; horizontal and/or vertical distances between an upper band of a tube of the hearing aid and the crus of the helix; horizontal and/or vertical distances between the middle band of a tube of the hearing aid and the cymba; the horizontal position of the tube and/or hearing aid dome relative to the concha and/or the entrance of the external auditory meatus; the position of the lower part of the tube in the vertical and horizontal plane relative to the tragus, antitragus and/or intertragic notch or any combination thereof. Each possibility is a separate embodiment.

Additionally, and/or alternatively, according to some embodiments, the correctness of the position of the hearing aid and/or a part thereof may identify a structural deficiency of the hearing aid and/or a part thereof by applying a machine learning algorithm on the determined position of the hearing aid and/or a part thereof and at least one anatomical landmark of the user's ear. According to some embodiments, the method may include training the machine learning algorithm to identify that a change in a hearing aid and/or part thereof is needed. According to some embodiments, the method may include training the machine learning algorithm to identify which structural element needs to be changed.

According to some embodiments, the determining of the correctness of the position of the hearing aid and/or a part thereof to identify a structural deficiency of the hearing aid and/or a part thereof by applying a machine learning algorithm on the determined position of the hearing aid and/or a part thereof and at least one anatomical landmark of the user's ear may comprise extracting features from the images such as, but not limited to, features regarding a relative distance and/or relative placement of the determined location of the hearing aid and/or parts thereof relative to the anatomical landmark of the ear. Non-limiting examples of suitable features for extraction include: a distance between the climax of the helix and a connection point between a body and tube of the hearing aid; horizontal and/or vertical distances between an upper band of a tube of the hearing aid and the crus of the helix; horizontal and/or vertical distances between the middle band of a tube of the hearing aid and the cymba; the horizontal position of the tube and/or hearing aid dome relative to the concha and/or the entrance of the external auditory meatus; the position of the lower part of the tube in the vertical and horizontal plane relative to the tragus, antitragus and/or intertragic notch or any combination thereof. Each possibility is a separate embodiment.

According to some embodiments, the method may include training the machine learning algorithm on the basis of training sets on how to correct and/or instruct a user on how to improve the correctness (e.g., position and/or structural deficiency) of a hearing aid and/or part thereof. According to some embodiments, the method may include training the machine learning algorithm to provide guidance to a user to reposition a hearing aid and/or part thereof to achieve a correct fit of the hearing aid in the user's ear in accordance with his/her unique anatomy.

According to some embodiments, the method may include training the machine learning algorithm to provide guidance to a user to change a structural element of the hearing aid to achieve a correct fit of the hearing aid in the user's ear in accordance with his/her unique anatomy.

According to some embodiments, the method may include a step of uploading the images to a cloud, wherein the processing of the plurality of images and/or the determining of the correctness of the position of hearing aid is/are performed in the cloud. It is understood that the “in-cloud” processing/analysis may significantly reduce the computational load required, which may be of significance in the elderly population who is often in possession of older computational devices (whether PCs or smartphones).

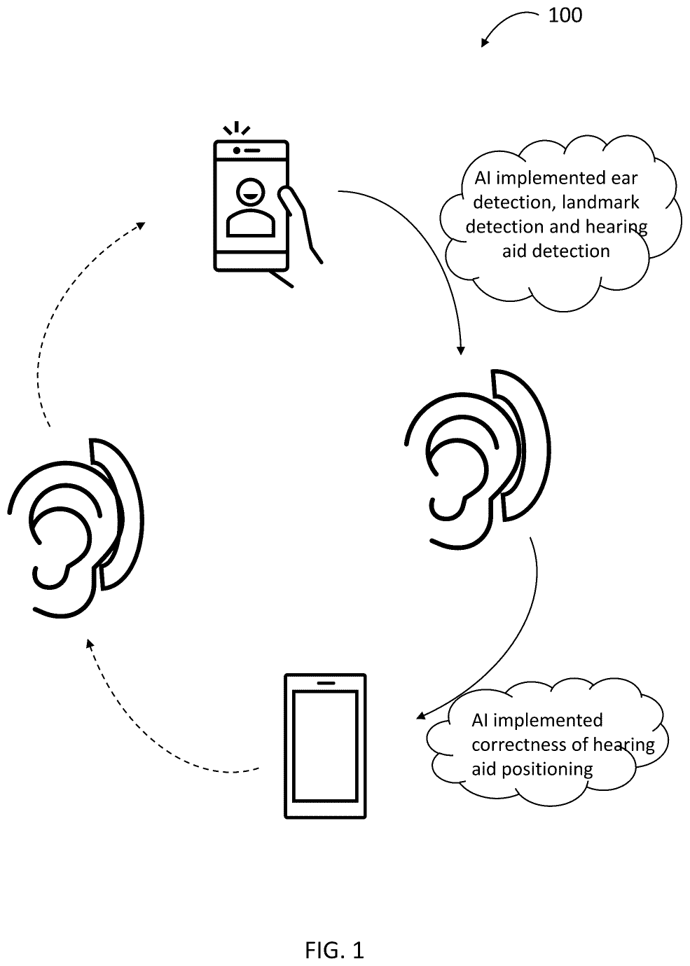

Reference is now made to FIG. 1, which illustratively depicts the herein disclosed method 100 for verifying correct hearing aid positioning, according to some embodiments.

Initially a hearing aid user is requested, e.g., via a user interface of a dedicated mobile App, to capture and/or to upload at least one frontal face image and at least one side face image, while wearing his/her hearing aid. It is understood that the image capturing may be done as a selfie or by another user and/or an assistant. Optionally, the App may include a feature of assisted image capturing. For example, the App may initially guide the user to position the camera and/or his/her head to frame the face in such manner that the ears are visible when capturing the frontal face image, by applying a face recognition tool, as essentially described herein. The App may then guide the user to position the camera and/or his/her head to frame the face in such a way that the entire ear is visible when capturing the frontal face image, by applying a face recognition tool, as essentially described herein. Optionally, when the user is wearing a hearing aid in both ears the side image capturing may be repeated for each side.

It is understood that the order of the image capturing may be opposite, such that initially side images may be captured, and then frontal images may be captured. Similarly, the number of images required in each position may vary from user to user, for example due to differences in the quality of the images captured (e.g., as a result of differences in camera quality, user position, camera position, user stillness, etc.)

Once the image capturing and/or image uploading (of previously acquired images) is completed, the images may be processed to extract, identify and/or measure at least one anatomical landmark of the user's ear and to identify the position of one or more parts of the hearing aid, wherein the processing comprises applying an image analysis algorithm on the plurality of images, as essentially described herein. According to some embodiments, the processing may be executed by an App on the processing circuit of a mobile device, tablet, smart watch, smart glasses, virtual reality device, personal computer or laptop. Alternatively, the images may be uploaded to a cloud for processing in order to reduce the computational load on the user's device.

Based on the extracted, identified and/or measured landmark(s) and the identified position of relevant parts of the hearing aid, the correctness of the position of the hearing aid part may be determined e.g., based on the features such as, the relative position of the hearing aid parts to one or more anatomical landmarks relevant thereto, by applying a trained machine learning algorithm, as essentially described herein. According to some embodiments, if the initial processing is performed on the App, the identified anatomical landmarks and device parts and/or the features extracted and/or measured therefrom may be sent to a cloud for further processing and/or classification. Alternatively, the entire processing may be carried out by the App or on the cloud in its entirety.

Once the correctness of the hearing aid position is determined, the App may provide/issue an indication to the user regarding same. Non-limiting examples of suitable indications include: a written message, a visual marker or audio message provided via the hearing aid, an audio signal provided via the hearing or any combination thereof. Each possibility is a separate embodiment.

According to some embodiments, providing an indication to the user regarding the correctness of the hearing aid position may include indicating if: the hearing aid is correctly positioned, or the hearing aid is incorrectly positioned. According to some embodiments, the indication may include a request to reposition the hearing aid and/or a part thereof. According to some embodiments, providing an indication to the user regarding the correctness of the hearing aid position may include indicating if a structural element of the hearing aid is required to be changed and/or identifying which structural element needs to be changed. According to some embodiments, the indication may include a request to change the identified structural element.

According to some embodiments, if the position of the hearing aid is determined to be correct, the indication may reflect same. Alternatively, if the position of the hearing aid and/or part thereof is determined to be incorrect, the indication may be a request to the user to reposition the hearing aid and/or part thereof. Optionally, repositioning may be followed by a recapturing of the plurality of images. Additionally, and/or alternatively, if a change of a structural element of the hearing aid is needed, the indication may be to request the user to change the structural element of the hearing aid. Optionally, changing the structural element may be followed by a recapturing of the plurality of images.

According to some embodiments, the request to reposition the hearing aid and/or part thereof may be in the form of instruction (visual and/or audio) regarding how to reposition. For example, the instructions may be to change an angle of the body of the hearing aid, to position the hearing aid lower or higher than the current position, instruction regarding positioning of the wire/tube on the pinna, instructions regarding position and depth of the receiver/tube inside the ear and/or ear canal. Optionally, the guided positioning may be continuous. For example, when the user is instructed to position the hearing aid lower or higher than the current position, the guidance may issue messages (audio or visual) such as “more” “less” or sounds or markers (red light, green like or the like) in a continuous manner until a correct position is achieved.

According to some embodiments, in case the user is instructed/recommended to change a structural element of the hearing aid, such instructions may be to change the dome of the hearing aid (from other standard domes having different size and/or shape or to a custom-made dome), instructions to change a length of the hearing aid tube and/or the receiver wire (from other standard tubes/receiver wires or to a custom-made hearing aid tube/receiver wire) or any combination thereof. Each possibility is a separate embodiment.

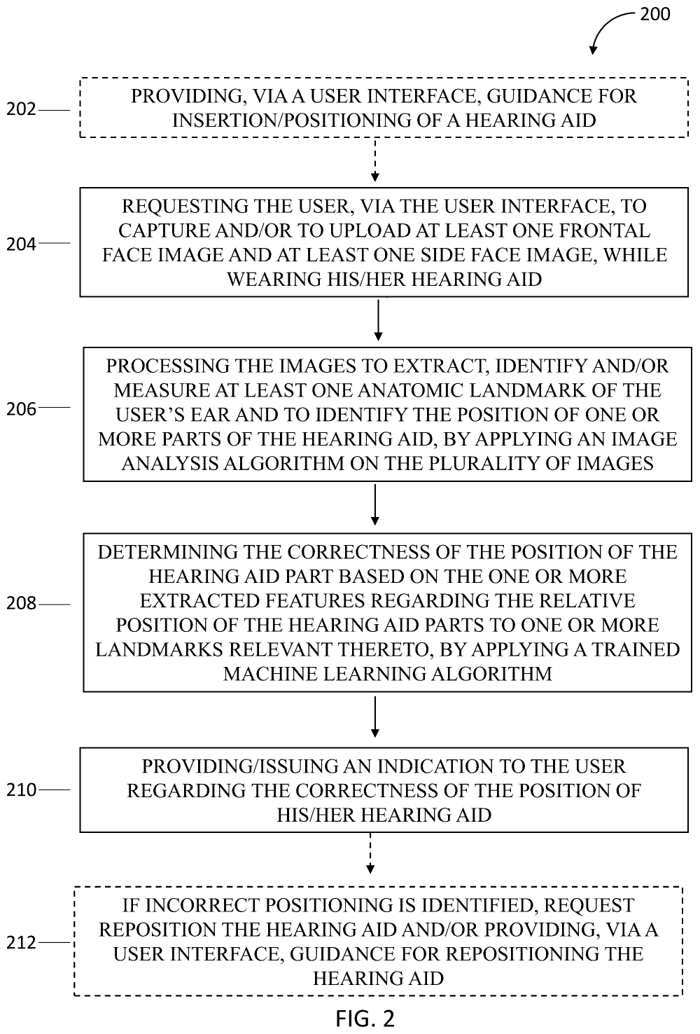

Reference is now made to FIG. 2, which is a flow chart 200 of a herein disclosed computer implemented method for verifying correct hearing aid positioning, according to some embodiments.

In step 202 (optional), a guided insertion/positioning of a hearing aid may be provided. According to some embodiments, the herein disclosed App for determining the correctness of hearing aid position may include a separate feature providing guided insertion/positioning of the hearing aid. According to some embodiments, a separate, dedicated “guided-positioning” App may be provided, which App may be directed to provide guided insertion/positioning of a hearing aid.

In step 204, the hearing aid user may be requested, e.g., via a user interface of a dedicated mobile App, to capture and/or to upload at least one frontal face image and at least one side face image, while wearing his/her hearing aid.

It is understood that image capturing may be done as a selfie, by another user or assistant, as essentially described herein. According to some embodiments, the App may include a feature for assisted image capturing. For example, the App may initially guide the user to position the camera and/or his/her head to frame the face in such manner that the ears are visible when capturing the frontal face image, by applying a face recognition tool, as essentially described herein. The App may then guide the user to position the camera and/or his/her head to frame the face in such a way that the ear is visible when capturing the frontal face image, by applying a face recognition tool, as essentially described herein. According to some embodiments, the guided insertion/positioning may include illustrations, images and/or videos. Each possibility is a separate embodiment.

Next, in step 206, the images may be processed to extract, identify and/or measure at least one anatomical landmark of the user's ear and to identify the position of one or more parts of the hearing aid, by applying an image analysis algorithm on the plurality of images, as essentially described herein.

According to some embodiments, the at least one anatomical landmark extracted, identified and/or measured may be selected from the climax of the helix, the angle of the pinna relative to the head, the crus of helix, the tragus, the intertragic notch, the antitragus, the entrance of the external auditory canal, the cavum and the d-shape of the pinna or any combination thereof.

According to some embodiments, the one or more parts of the hearing aid may be selected from the body of the hearing aid, the hearing aid tube, the connection element connecting between the hearing aid body and the hearing aid tube, the upper band of the tube, the lower band of the tube, the retainer of the tube, the silicone dome, or any combination thereof. Each possibility is a separate embodiment.

In step 208, the correctness of the position of the hearing aid part may be determined, e.g., based on the one or more extracted features, such as the relative position of the hearing aid parts to one or more anatomical landmarks of the user's ear, relevant thereto, by applying a trained machine learning algorithm, as essentially described herein.

According to some embodiments, the one or more extracted features may be selected from: a distance between a climax of a helix of the subject's ear and a connection point between a body and a tube of the hearing aid, a horizontal and/or vertical distance between an upper band of the tube of the hearing aid and a crus of the helix of the subject's ear, a horizontal and/or vertical distance between a middle band of the tube of the hearing aid and the cymba of the subject's ear, a horizontal position of the hearing aid tube and/or a dome of the hearing aid relative to the concha and/or an entrance of an external auditory meatus of the subject's ear, a position of a lower part of the hearing aid tube in a vertical and/or horizontal plane relative to a tragus, antitragus and/or intertragic notch of the subjects ear, the body of the hearing aid, the hearing aid tube, the connection element connecting between the hearing aid body and the hearing aid tube, the upper band of the tube, the lower band of the tube, the retainer of the tube, the silicone dome or any combination thereof. Each possibility is a separate embodiment.

In step 210, the App may provide/issue an indication to the user regarding the correctness of the position of the hearing aid with respect to the individual user's unique anatomy. According to some embodiments, the indication may be in the form of a written message, a visual marker or audio message provided via the hearing aid, an audio signal provided via the hearing or any combination thereof. Each possibility is a separate embodiment.

According to some embodiments, if the position of the hearing aid is determined to be correct for the individual user's unique anatomy, the indication may reflect same. Alternatively, if the position of the hearing aid is determined to be incorrect, the indication may be a request to the user to reposition the hearing aid and/or a part thereof and/or to change a structural element of the hearing aid (e.g., step 210).

According to some embodiments, the indication may be based on an identified need (e.g., identified incorrect positioning of the hearing aid and/or a part thereof) to reposition the hearing aid and/or a part thereof.

In step 212, the App may optionally provide, via a user interface, guidance for repositioning the hearing aid. Following repositioning of the hearing aid and/or a part thereof, a second set of a plurality of images may be captured and analyzed as in the steps above. Optionally, this process may be iterated and/or repeated until a correct fit of the hearing aid is achieved.

According to some embodiments, the request to reposition the hearing aid may be in the form of instruction (visual and/or audio) regarding how to reposition. For example, the instructions may be to change an angle of the body of the hearing aid, to position the hearing aid lower or higher than the current position, instruction regarding positioning of the wire/tube on the pinna, instructions regarding position and depth of the receiver/tube inside the ear and/or ear canal. Optionally, the guided positioning may be continuous. For example, when the instructions are to position the hearing aid lower or higher than the current position, the guidance may issue messages (audio or visual) such as “more”, “less”, or sounds or markers (direction arrows, red light, green like or the like) until a correct position is achieved.

According to some embodiments, there is provided a method for guided insertion/positioning of a hearing aid. According to some embodiments, the method may be a separate feature of the herein disclosed App for providing guided insertion/positioning of a hearing aid. According to some embodiments, a separate App may be provided, which App may be dedicated to providing guided insertion/positioning of a hearing aid.

According to some embodiments, the guided insertion/positioning may include illustrations, images and/or videos. Each possibility is a separate embodiment.

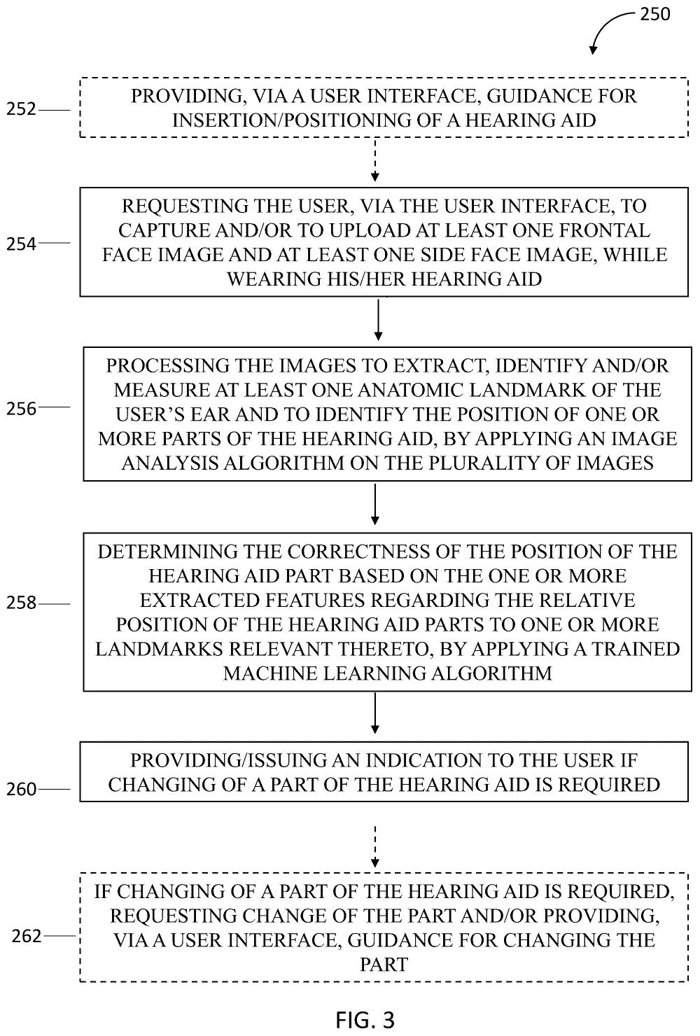

Reference is now made to FIG. 3, which is a flow chart 250 of the herein disclosed computer implemented method for verifying fit of hearing aid parts, according to some embodiments.

In step 252 (optional), a guided insertion/positioning of a hearing aid may be provided. According to some embodiments, the herein disclosed App for determining the correctness of hearing aid position may include a separate feature providing guided insertion/positioning of the hearing aid. According to some embodiments, a separate, dedicated “guided-positioning” App may be provided, which App may be directed to provide guided insertion/positioning of a hearing aid.

In step 254, the hearing aid user may be requested, e.g., via a user interface of a dedicated mobile App, to capture and/or to upload at least one frontal face image and at least one side face image, while wearing his/her hearing aid.

It is understood that image capturing may be done as a selfie, by another user or assistant, as essentially described herein. According to some embodiments, the App may include a feature for assisted image capturing. For example, the App may initially guide the user to position the camera and/or his/her head to frame the face in such manner that the ears are visible when capturing the frontal face image, by applying a face recognition tool, as essentially described herein. The App may then guide the user to position the camera and/or his/her head to frame the face in such a way that the ear is visible when capturing the frontal face image, by applying a face recognition tool, as essentially described herein. According to some embodiments, the guided insertion/positioning may include illustrations, images and/or videos. Each possibility is a separate embodiment.

Next, in step 256, the images may be processed to extract, identify and/or measure at least one anatomical landmark of the user's ear and to identify the position of one or more parts of the hearing aid, by applying an image analysis algorithm on the plurality of images, as essentially described herein.

According to some embodiments, the at least one anatomical landmark extracted, identified and/or measured may be selected from the climax of the helix, the angle of the pinna relative to the head, the crus of helix, the tragus, the intertragic notch, the antitragus, the entrance of the external auditory canal, the cavum and the d-shape of the pinna or any combination thereof.

According to some embodiments, the one or more parts of the hearing aid may be selected from the body of the hearing aid, the hearing aid tube, the connection element connecting between the hearing aid body and the hearing aid tube, the upper band of the tube, the lower band of the tube, the retainer of the tube, the silicone dome or any combination thereof. Each possibility is a separate embodiment.

In step 258, the correctness of the position of the hearing aid part may be determined, e.g., based on the one or more extracted features, such as the relative position of the hearing aid parts to one or more anatomical landmarks of the user's ear, relevant thereto, by applying a trained machine learning algorithm, as essentially described herein.

According to some embodiments, the one or more extracted features may be selected from: a distance between a climax of a helix of the subject's ear and a connection point between a body and a tube of the hearing aid, a horizontal and/or vertical distance between an upper band of the tube of the hearing aid and a crus of the helix of the subject's ear, a horizontal and/or vertical distance between a middle band of the tube of the hearing aid and the cymba of the subject's ear, a horizontal position of the hearing aid tube and/or a dome of the hearing aid relative to the concha and/or an entrance of an external auditory meatus of the subject's ear, a position of a lower part of the hearing aid tube in a vertical and/or horizontal plane relative to a tragus, antitragus and/or intertragic notch of the subjects ear, the body of the hearing aid, the hearing aid tube, the connection element connecting between the hearing aid body and the hearing aid tube, the upper band of the tube, the lower band of the tube, the retainer of the tube, the silicone dome or any combination thereof. Each possibility is a separate embodiment.

In step 260, the App may provide and/or issue an indication to the user regarding if changing of a part of the hearing aid is required. According to some embodiments, the indication may be in the form of a written message, a visual marker or audio message provided via the hearing aid, an audio signal provided via the hearing or any combination thereof. Each possibility is a separate embodiment.

According to some embodiments, if the position, type, and size of the hearing aid part is determined to be correct for the individual user's unique anatomy, the indication may reflect same. Alternatively, if changing a part of the hearing aid is determined to be needed, the indication may be a request to the user to change a part of the hearing aid (e.g., step 262).

According to some embodiments, the indication may be based on an identified structural deficiency of the hearing aid with respect to the unique anatomy of a user's ear and/or identification of which structural element needs to be changed.

According to some embodiments, the indication may be a request to change an identified structural element. According to some embodiments, the request to change a structural element may be to change the dome of the hearing aid (from other standard domes having different size and/or shape or to a custom-made dome), instructions to change a length of the hearing aid tube and/or the receiver wire (standard or custom made) or any combination thereof.

According to some embodiments, the request to change a part of the hearing aid may be in the form of instruction (visual and/or audio) regarding how to change the part. For example, the instructions may be to change the length of the hearing aid tube (e.g. from a plurality of standard sizes), the diameter of the hearing aid tube (e.g. from a plurality of standard sizes), a change in the hearing aid dome utilized, such as, but not limited to, changing the size of the hearing aid dome (e.g. from a plurality of standard sizes), changing the type of the hearing aid dome (e.g. from a plurality of standard dome types), or changing to a custom made earmold. Each possibility is a separate embodiment.

In step 264, the App may optionally provide, via a user interface, guidance for changing the structural element. Following changing a structural element, a second set of a plurality of images may be captured and analyzed as in the steps above. Optionally, this process may be iterated and/or repeated until a correct fit of the hearing aid is achieved.

According to some embodiments, there is provided a method for guided changing hearing aid parts. According to some embodiments, the method may be a separate feature of the herein disclosed App. According to some embodiments, a separate App may be provided, which App may be dedicated to providing guidance on changing hearing aid parts and/or maintenance of a hearing aid and/or parts thereof.

According to some embodiments, the guidance for changing hearing aid parts and/or maintenance of a hearing aid may include illustrations, images and/or videos. Each possibility is a separate embodiment.

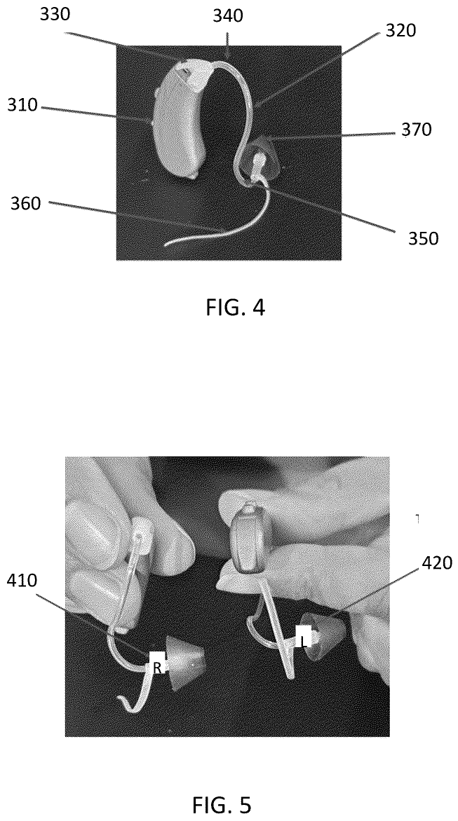

According to some embodiments, the guided insertion/positioning of a hearing aid may include visuals of the different hearing aid parts, as illustrated in FIG. 4.
310: The body of the hearing aid
320: Hearing aid tube.
330: Connection point of the body and the tube of the hearing aid.
340: First upper band of the hearing tube:
350: lower band of the hearing tube.
360: Retainer of the hearing tube.
370: Hearing aid dome.

According to some embodiments, the guided insertion/positioning of a hearing aid may include visual and/or textual guidance to distinguishing between a left and right hearing aid. For example, the right hearing aid is signed by a red indicator or the letter R 410 on the hearing aid or on the tube of the hearing aid, and the left hearing aid is signed by a blue indicator or the letter L 420 on the hearing aid or on the tube of the hearing aid, as shown in FIG. 5.

According to some embodiments, the guided insertion/positioning may include text and/or visuals providing a step-wise guide to the positioning of the hearing aid. According to some embodiments, the steps may include some or all of the below described steps. According to some embodiments, the step-wise guide may include both text and/or visuals, such as, but not limited to, the below described steps and accompanying figures.

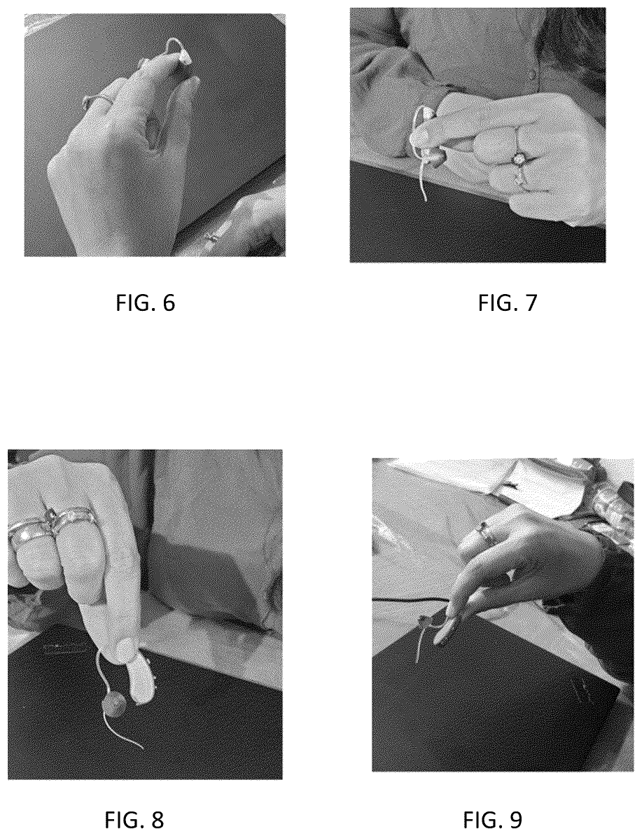

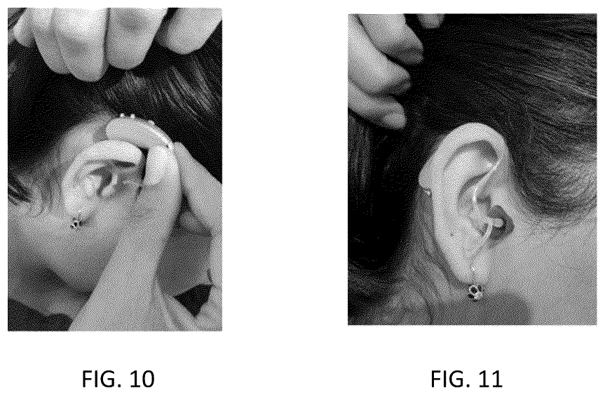

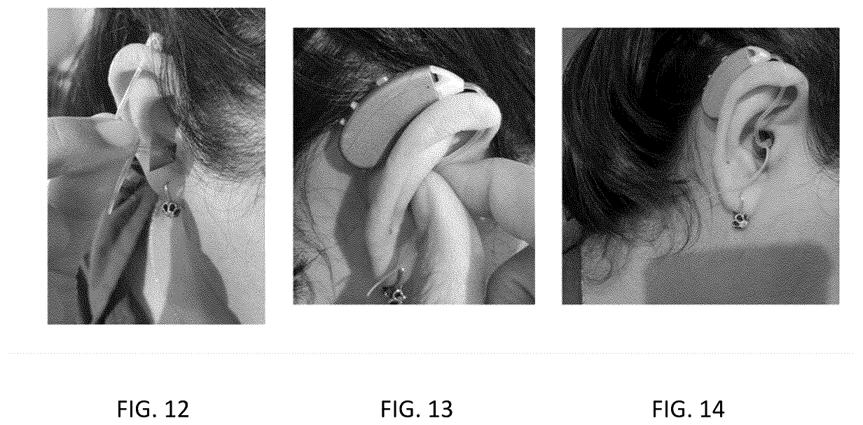

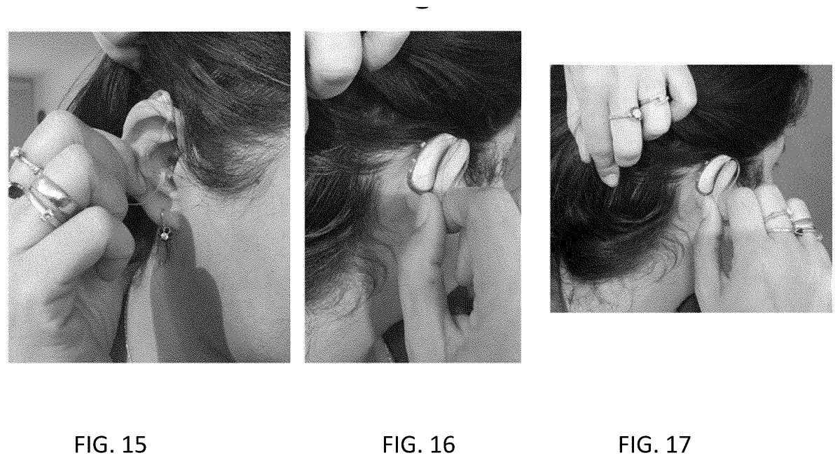

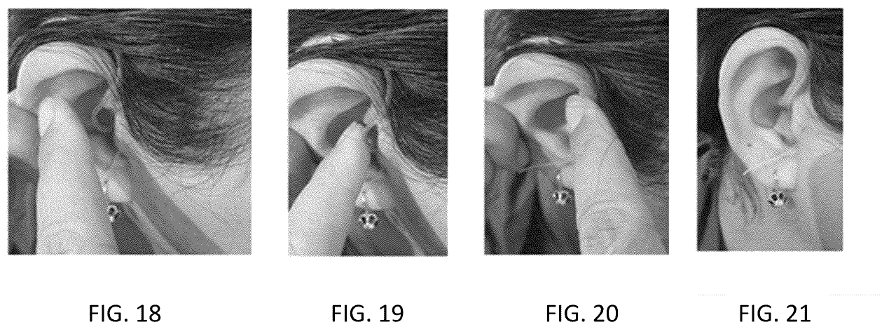

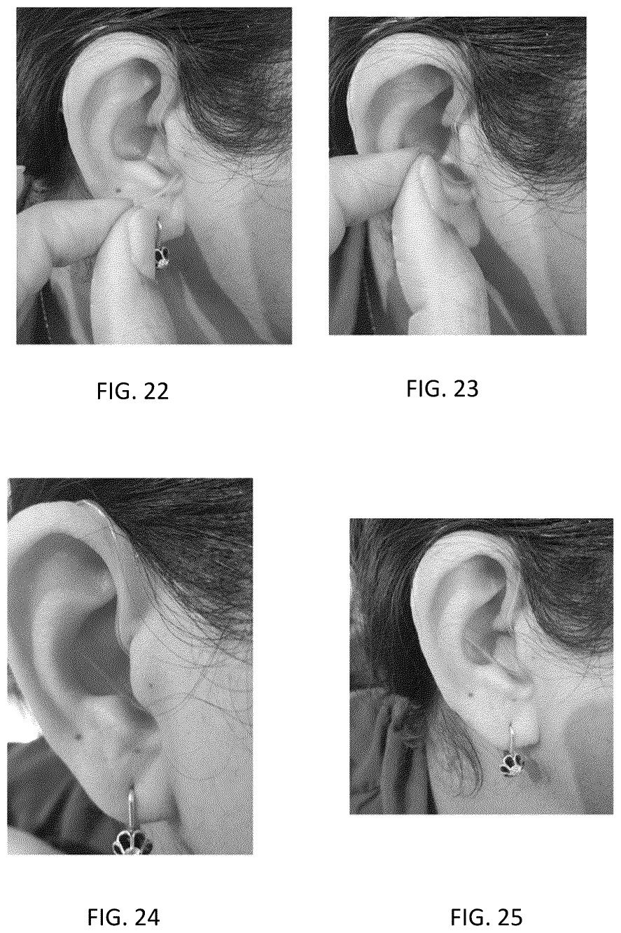

Reference is now made to FIGS. 6-25, which are illustrative images visualizing the exemplary steps for insertion of right hearing aid:
Step 1: With your non-dominant hand, hold the right hearing aid body so that when it is directed to your torso the tube is to the front (opposite side of the body)—FIGS. 6-7.
Step 2: Use the index and the thumb fingers of your dominant hand and grab the upper part of the right hearing aid, where it connects with the tube. Release the non-dominant hand. The hearing aid body should be directed toward your body—FIGS. 8-9.
Step 3: Locate the body of the hearing aid behind the right ear, the upper curve of the tube should be worn on the edge of the pinna—FIGS. 10-11.
Step 4: Hold the lower curve of the tube and position the silicone dome at the entrance of the ear canal—FIGS. 12-14.
Step 5: With the index and thumb of the right hand, grab the middle part of the pinna, pull backwards and keep it stretched—FIGS. 15-17.
Step 6: Use the index finger of the left hand to slowly push the lower curve of the tube and the silicone dome as deep as possible into the ear canal—FIGS. 18-21.
Step 7: Release the hands from the ear and hold the retainer and put it in your ear—FIGS. 22-23.
Step 8: At the end of the insertion process, the tube should be attached to the pinna and should not pop out of the ear—FIGS. 24-25.

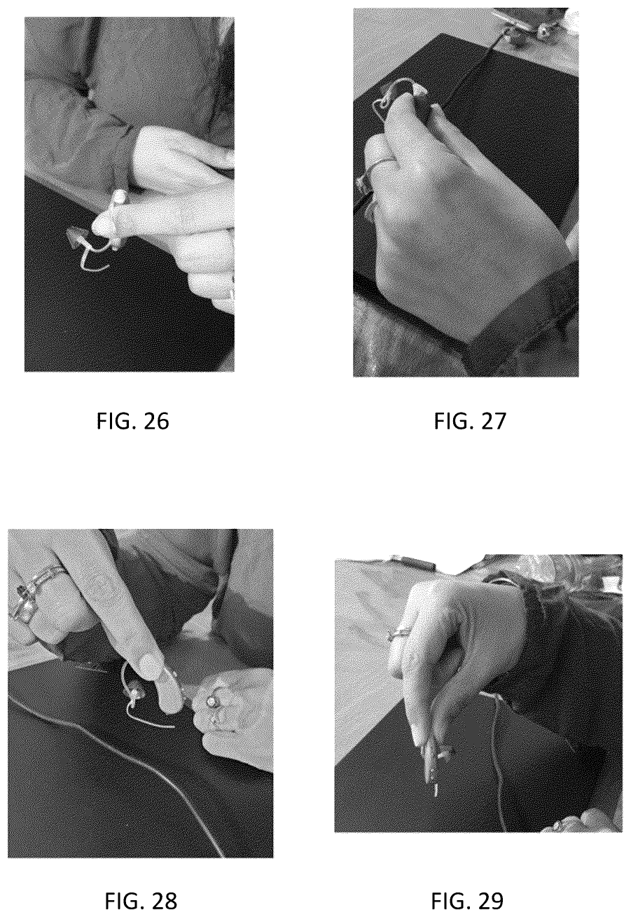

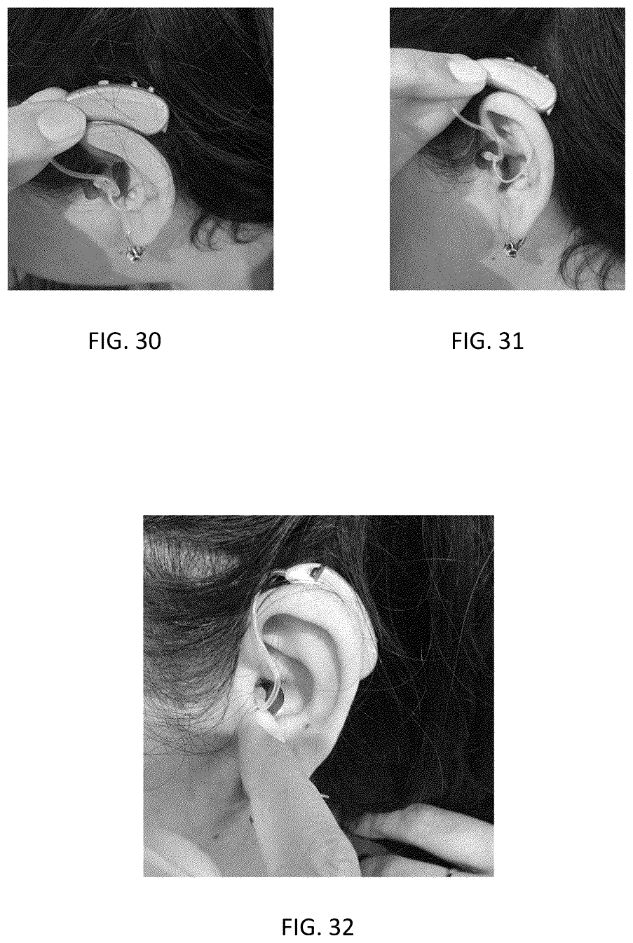

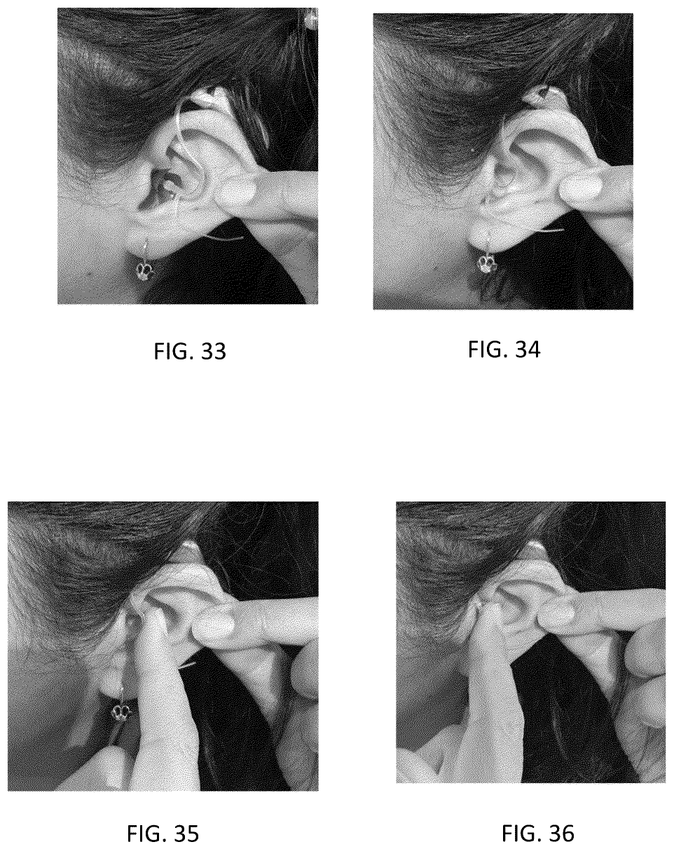

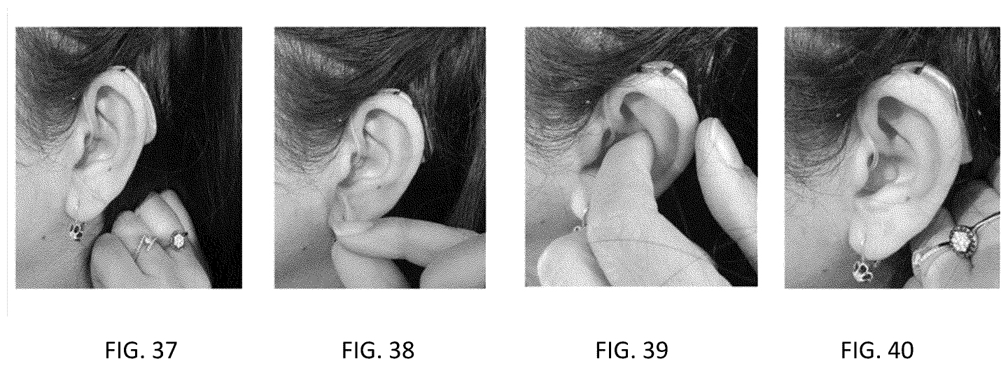

Reference is now made to FIG. 26-40, which are illustrative images visualizing the following exemplary steps for insertion of left hearing aid:
Step 1: With your non-dominant hand, hold the left hearing aid body so that when it is directed to your torso the tube is to the front (opposite side of the body)—FIGS. 26-27.
Step 2: Use the index and the thumb fingers of your dominant hand and grab the upper part of the hearing aid where it connects with the tube. Release the non-dominant hand—FIGS. 28-29.
Step 3: Locate the body of the hearing aid behind the left ear, the upper curve of the tube should be worn on the edge of the pinna—FIGS. 30-31.
Step 4: Hold the lower curve of the tube and position the silicone dome at the entrance of the ear canal—FIG. 32.
Step 5: With the index and thumb of the left hand, grab the middle part of the pinna, pull it backwards and keep it stretched—FIG. 33-34.
Step 6: Use the index finger of the right hand to slowly push the lower curve of the tube and the silicone dome as deep as possible into the ear canal—FIGS. 35-36.
Step 7: Release the hands from the ear.
Step 8: At the end of the insertion process the tube should be attached to the pinna and should not pop out of the ear—FIGS. 37-40.

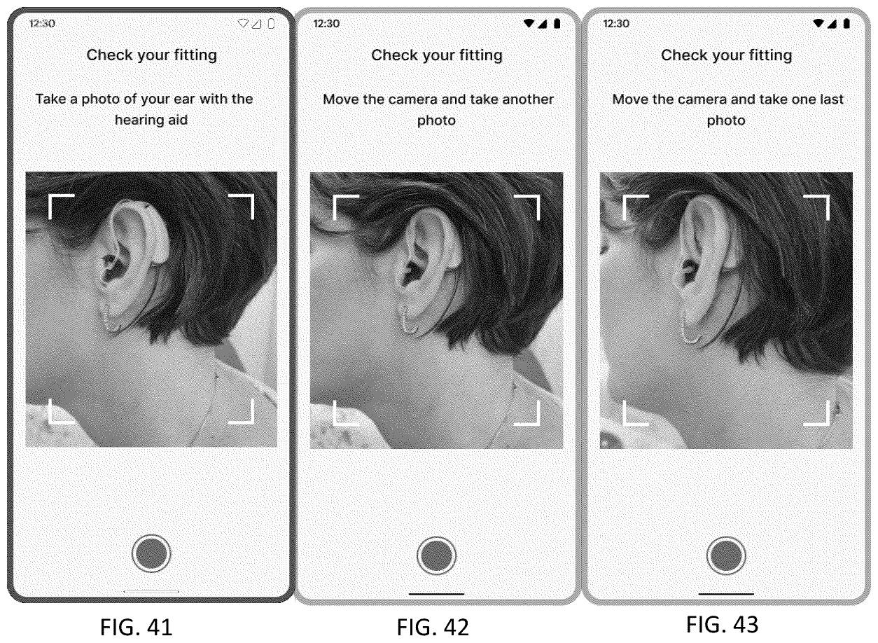

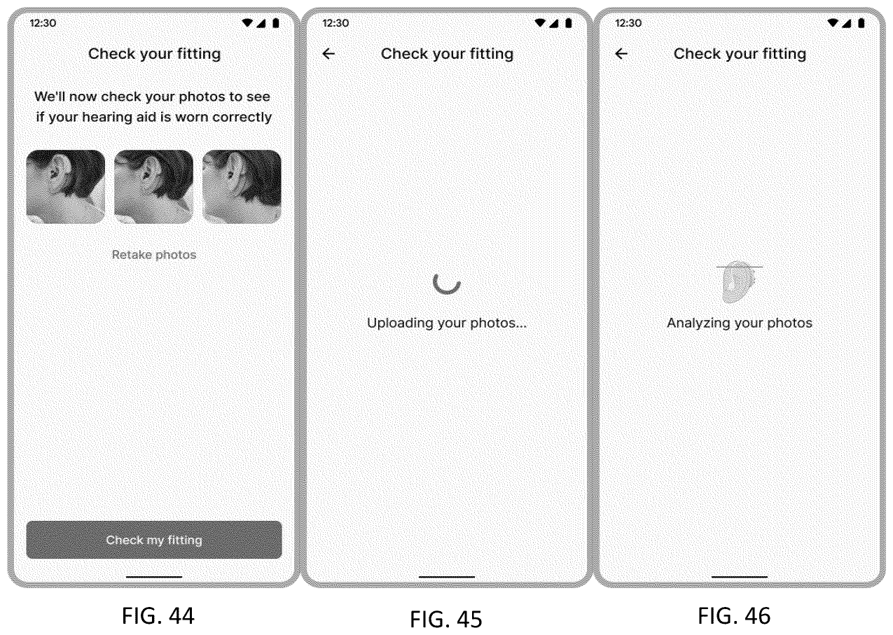

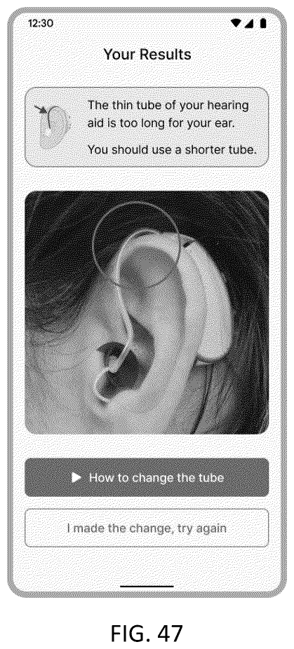

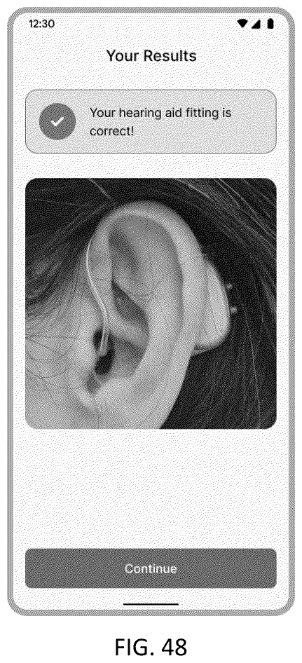

Reference is now made to FIG. 41-FIG. 48, which are illustrative images visualizing the following steps for verifying the position of the hearing aid parts, issuing an indication to the user if changing of a part of the hearing aid is needed, and optionally providing guidance for changing the part:
Step 1: The camera is turned on and the user is prompted to take several photographs of their ear with the hearing aid, e.g., a front view, side view, back view, various perspective views, etc. In FIGS. 41-43, examples of various acceptable photographs of side view images are shown.
Step 2: After the user confirms that the ear with the hearing aid is visible in the photographs, the photographs are uploaded to the server and analyzed by a trained machine learning algorithm—FIGS. 44-46.
Step 3: The results of the analysis are shown. In FIG. 47, the algorithm has detected that the hearing aid is not correctly fitted and has identified that there is a need to change a specific part of the hearing aid (the tube) because it is too long to fit the anatomy of this particular user's ear. Optionally, the system may offer to provide instructions for how to correct the problem e.g., how to change the tube.
Step 4: Once the user has corrected the problem, the user can upload new photographs and the process may be repeated until a correct fit of the hearing aid is achieved—FIG. 48.

Additionally, and/or alternatively, in Step 3, the algorithm may detect that the hearing aid is not correctly positioned, and that there is a need to reposition the hearing aid and/or a part thereof. Optionally, the system may offer to provide instructions for how to correct the problem e.g., how to reposition the hearing aid and/or a part thereof.

For convenience, certain terms used in the specification, examples, and appended claims are collected here. Unless otherwise defined, all technical and scientific terms used herein have the same meaning as commonly understood by one of ordinary skills in the art to which this invention pertains.

As used herein, the term “personalized” in the context of the herein disclosed system and method/platform for hearing aid adjustment refers to a system and method/platform for hearing aid adjustment, which is configured to meet the hearing aid user's individual requirement, based on his/her perceived hearing experience.

As used herein, the terms “approximately”, “essentially” and “about” in reference to a number are generally taken to include numbers that fall within a range of 5% or in the range of 1% in either direction (greater than or less than) the number unless otherwise stated or otherwise evident from the context (except where such number would exceed 100% of a possible value). Where ranges are stated, the endpoints are included within the range unless otherwise stated or otherwise evident from the context.

As used herein, the singular forms “a,” “an” and “the” include plural referents unless the context clearly dictates otherwise.

As used herein, “optional” or “optionally” means that the subsequently described event or circumstance does or does not occur, and that the description includes instances where said event or circumstance occurs and instances where it does not.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods, according to some embodiments, may be described in a specific sequence, the methods of the disclosure may include some or all of the described stages carried out in a different order. In particular, it is to be understood that the order of stages and sub-stages of any of the described methods may be reordered unless the context clearly dictates otherwise, for example, when a latter stage requires as input an output of a former stage or when a latter stage requires a product of a former stage. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications, and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

1. A computer implemented method for determining hearing aid position correctness with respect to the unique anatomy of a specific user's ear, the method comprising:
requesting, via a user interface, a hearing aid user to capture and/or upload a plurality of images, the plurality of images comprising at least one frontal face image and at least one side face image, wherein the plurality of images is captured while the user is wearing a hearing aid,
applying a facial landmark algorithm on the plurality of images to identify a position of an ear of the user, at least one anatomical landmark of the ear and one or more parts of the hearing aid;
deriving, from the determined position of the at least one anatomical landmark of the ear of the user and from the one or more parts of the hearing aid, one or more features related to a relative position of the hearing aid relative to the at least one anatomical landmark of the ear of the user in the plurality of images;
determining the correctness of a position of the hearing aid by applying a machine learning algorithm on the one or more features, wherein the machine learning algorithm is trained using a training set comprising a large plurality of images of ears with hearing aids and a plurality of labels associated with the large plurality of images, each label indicating whether the hearing aid is correctly or incorrectly positioned, wherein the large plurality of images comprises images of ears of different subjects and wherein the large plurality of images comprises at least two images of each ear from different angles thereof;
wherein the machine algorithm is trained to differentiate between the following scenarios:
a) the hearing aid is correctly positioned;
b) the hearing aid is incorrectly positioned; and
c) a structural element of the hearing aid needs to be changed;
providing an indication to the user regarding the correctness of the hearing aid position, wherein if the hearing aid is correctly positioned, the indication is indicative of same;
wherein if incorrect positioning is identified, the indication comprises a request to reposition the hearing aid, or
wherein if changing of a structural element of the hearing aid is required, the indication comprises a request to change the structural element.

2. The method of claim 1, further comprising extracting the at least one anatomical landmark of the user's ear, wherein the extracting comprises applying an image analysis algorithm on the plurality of images.

3. The method of claim 2, wherein the at least one landmark comprises a climax of the helix, an angle of the pinna relative to the head, the crus of helix, the tragus, the intertragic notch, the antitragus, an entrance of the external auditory canal, the cavum and a d-shape of the pinna or any combination thereof.

4. The method of claim 1, wherein the one or more features comprises two or more of: a distance between a climax of a helix of the ear of the user and a connection point between a body and a tube of the hearing aid, a horizontal and/or vertical distance between an upper band of the tube of the hearing aid and a crus of the helix of the ear of the user, a horizontal and/or vertical distance between a middle band of the tube of the hearing aid and the cymba of the ear of the user, a horizontal position of the hearing aid tube and/or a dome of the hearing aid relative to the concha and/or the entrance of the external auditory meatus of the ear of the user, a position of a lower part of the hearing aid tube in a vertical and/or horizontal plane relative to a tragus, antitragus and/or intertragic notch of the ear of the user.

5. The method of claim 1, wherein the at least one side face image comprises at least one left-side face image and at least one right-side face image.

6. The method of claim 1, wherein the plurality of images are still images.

7. The method of claim 1, wherein the plurality of images are derived from a video.

8. The method of claim 1, wherein the request to reposition the hearing aid comprises instruction regarding how to reposition.

9. The method of claim 8, wherein the instructions comprises instructions to change an angle of a body of the hearing aid, instruction to position the hearing aid lower or higher than a current position, instruction regarding positioning of a wire/tube on the pinna, instructions regarding position and depth of a receiver/tube inside the ear and/or ear canal, instructions to change a dome of the hearing aid, instructions to change a length of a hearing aid tube and/or a receiver wire or any combination thereof.

10. The method of claim 1, wherein the structural element is selected from a tube length, a tube depth, a standard silicon dome size, a standard silicon dome type, or a custom made earmold.

11. The method of claim 1, wherein the method is executed via an App and wherein the capturing of the plurality of images is carried out using a camera of a mobile phone or tablet installed with the App.

12. The method of claim 11, wherein the method further comprises guiding the capturing of the plurality of images.

13. The method of claim 12, wherein the guiding comprises instructing the user to position the camera for capturing a frontal face image and determining correct face position relative to an image frame of the camera by applying a face recognition tool.

14. The method of claim 13, wherein the guiding further comprises instructing the user to turn the face sideways and determining correct face position based on automatic identification of the ear of the user.

15. The method of claim 1, further comprising an initial step of guided insertion/positioning of a hearing aid.

16. The method of claim 1, wherein the large plurality of images comprises a first image of an ear with a correctly positioned hearing aid and a second image of the same ear with an incorrectly positioned hearing aid.

17. The method of claim 1, further comprising extracting a plurality of features from each of the large plurality of images.

18. The method of claim 17, further comprising selecting a subset of features from the plurality of features, which subset have a predictive value above a predetermined threshold.

19. A system for determining hearing aid positioning correctness with respect to the unique anatomy of a specific user's ear, the system comprising a processing logic configured to:
request a hearing aid user to capture a plurality of images, the plurality of images comprising at least one frontal face image and at least one side face image, wherein the plurality of images is captured while the user is wearing a hearing aid;
process the plurality of images to determine the position of at least one anatomical landmark of the user's ear and of one or more parts of the hearing aid, wherein the processing comprises applying a facial landmark algorithm on the plurality of images to identify a position of an ear of the user, at least one anatomical landmark of the ear and one or more parts of the hearing aid;
deriving, from the determined position of the at least one anatomical landmark of the ear of the user and from one or more parts of the hearing aid, one or more features related to a relative position of the hearing aid relative to the at least one anatomical landmark of the ear of the user in the plurality of images;
determine the correctness of a position of the hearing aid by applying a machine learning algorithm on the one or more derived features, wherein the machine learning algorithm is trained using a training set comprising a large plurality of images of ears with hearing aids and a plurality of labels associated with the large plurality of images, each label indicating whether the hearing aid is correctly or incorrectly positioned, wherein the large plurality of images comprises images of ears of different subjects and wherein the large plurality of images comprises at least two images of each ear from different angles thereof;
wherein the machine algorithm is trained to differentiate between the following scenarios:
a) the hearing aid is correctly positioned;
b) the hearing aid is incorrectly positioned; and
c) a structural element of the hearing aid needs to be changed;
provide an indication to the user regarding the correctness of the hearing aid position, wherein if the hearing aid is correctly positioned, the indication is indicative of same;
wherein if incorrect positioning is identified, the indication comprises a request to reposition the hearing aid, or
wherein if changing of a structural element of the hearing aid is required, the indication comprises a request to change the structural element.

20. A computer implemented method for determining hearing aid position correctness with respect to the unique anatomy of a specific user's ear, the method comprising:
requesting, via a user interface, a hearing aid user to capture and/or upload a plurality of images, the plurality of images comprising at least one frontal face image and at least one side face image, wherein the plurality of images is captured while the user is wearing a hearing aid,
applying a facial landmark algorithm on the plurality of images to identify a position of an ear of the user, at least one anatomical landmark of the ear and one or more parts of the hearing aid;
deriving, from the determined position of the at least one anatomical landmark of the ear of the user and from the one or more parts of the hearing aid, one or more features related to a relative position of the hearing aid relative to the at least one anatomical landmark of the ear of the user in the plurality of images;
determining the correctness of a position of the hearing aid by applying a machine learning algorithm on the one or more features, wherein the machine learning algorithm is trained using a training set comprising a large plurality of images of ears with hearing aids and a plurality of labels associated with the large plurality of images, each label indicating whether the hearing aid is correctly or incorrectly positioned, wherein the large plurality of images comprises images of ears of different subjects and wherein the large plurality of images comprises at least two images of each ear from different angles thereof;
wherein the machine algorithm is trained to identify whether a structural element of the hearing aid needs to be changed in order to achieve a correct fit of the hearing aid to the unique anatomy of the user's ear;
wherein if changing of a structural element of the hearing aid is required, the algorithm is configured to identify which structural element needs to be changed, and to provide a request to the user to change the identified structural element.
